(19) United States
(12) Patent Application Publication
(10) Pub. No.: US 2018/0184381 A1
(43) Pub. Date: Jun. 28, 2018

(54) RADIO MANAGEMENT

(71) Applicant: BandwidthX Inc., Carlsbad, CA (US)

(72) Inventor: Chris VAN HAMERSVELD, San Marcos, CA (US)

(21) Appl. No.: 15/848,534

(22) Filed: Dec. 20, 2017

Related U.S. Application Data
(60) Provisional application No. 62/439,386, filed on Dec. 27, 2016.

(51) Int. Cl. H04W 52/02

(52) U.S. Cl. CPC H04W 52/0254; H04W 84/12; H04W 52/0229; H04W 52/0216

(57) ABSTRACT

Systems, methods, and media for radio management in a mobile device with two or more radio systems. In an embodiment, a change from a first activity to a second activity is detected. Each activity indicates a likelihood for use of a second radio system (e.g., a likelihood that use of the second radio system is available). In response to the change, when the likelihood indicated by the second activity is higher than the likelihood indicated by the first activity, an aggressiveness with which the second radio system scans an environment of the mobile device for available access points is increased, and, when the likelihood indicated by the second activity is lower than the likelihood indicated by the first activity, an aggressiveness with which the second radio system scans the environment of the mobile device for available access points is decreased.

### CROSS-REFERENCE TO RELATED APPLICATIONS

The present application claims priority to U.S. Provisional Patent App. No. 62/439,386, filed on Dec. 27, 2016, which is hereby incorporated herein by reference as if set forth in full.

### BACKGROUND

### Field of the Invention

The embodiments described herein are generally directed to radio management, and, more particularly, to managing when a radio is aggressive or passive and/or active or inactive within a mobile device.

### Description of the Related Art

Conventionally, radio management has used variable scheduling to decide when to scan for a connection opportunity. However, improved radio management includes triggers that cause the radio to turn on and perform a scan. These triggers may facilitate timelier connections, for example, by checking for circumstances in which the device is likely at a destination where a Wi-Fi™ connection may be possible.

Radio management can generally be enabled and disabled using policy rules. This is important to carriers that only want active radio management and Wi-Fi™ offload in certain conditions, such as when a mobile device is roaming, when a mobile device is receiving little to no cellular signal, or when the mobile device is in a geographical region during a certain time frame.

The primary driver for implementing a solid radio management strategy is to balance the needs of the user (e.g., connecting to hotspots) with the limited resources (e.g., battery power) available. The radio should be off as much as possible to save battery power, and would ideally only be turned on at those exact moments when a connection opportunity presents itself.

### SUMMARY

Accordingly, systems, methods, and media are disclosed for radio management.

In an embodiment, a method is disclosed for a mobile device comprising a first radio system and a second radio system and capable of performing radio management of at least the second radio system. The method comprises using at least one hardware processor to: detect a change from a first activity to a second activity performed by a user of a mobile device, wherein each of the first activity and the second activity indicates a likelihood for use of the second radio system (e.g., a likelihood that use of the second radio system is available); and, in response to the detected change from the first activity to the second activity, when the likelihood indicated by the second activity is higher than the likelihood indicated by the first activity, increase an aggressiveness with which the second radio system scans an environment of the mobile device for available access points, and, when the likelihood indicated by the second activity is lower than the likelihood indicated by the first activity, decrease an aggressiveness with which the second radio system scans the environment of the mobile device for available access points.

In an embodiment, a method is disclosed for a mobile device comprising a first radio system and a second radio system and capable of performing radio management of at least the second radio system. The method comprises using at least one hardware processor to: maintain a log comprising an entry for each of one or more past connections established by the second radio system, wherein each entry comprises a location of the past connection and an identifier of an access point with which the past connection was established; acquire a current location of the mobile device; determine whether or not the current location is within a predetermined range from a location in at least one entry in the log; and, when the current location is determined to be within the predetermined range from a location in at least one entry in the log, control the second radio system to scan for only the access point in the at least one entry.

In an embodiment, a method is disclosed for a mobile device comprising a first radio system and a second radio system and capable of performing radio management of at least the second radio system. The method comprises using at least one hardware processor to: detect a change in a condition of the mobile device; and, when the change in condition of the mobile device is detected, turn the radio management of the second radio system on or off.

Any of the methods may be embodied in executable software modules of a processor-based system and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processed described herein, may be executed, according to an embodiment; and

FIGS. 3-5 illustrate processes for radio management, according to embodiments.

### DETAILED DESCRIPTION

Embodiments of systems, methods, and non-transitory computer-readable media are disclosed for radio management. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

1. System Overview

1.1. Infrastructure

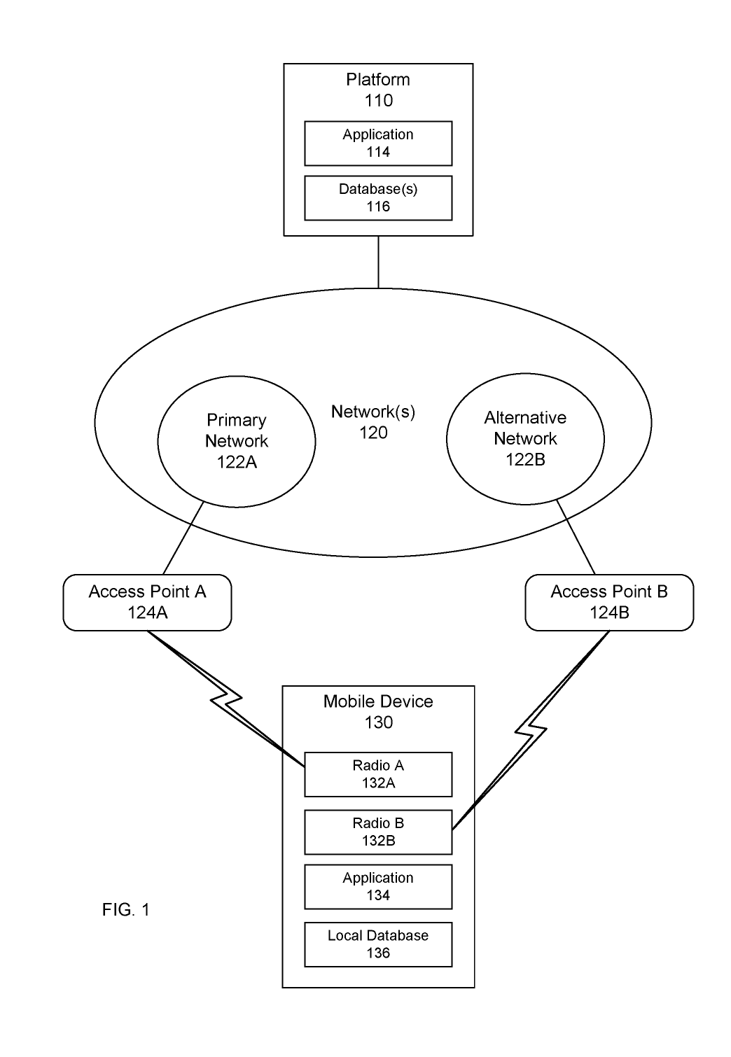

FIG. 1 illustrates an example system in which radio management may occur, according to an embodiment. The infrastructure may comprise a platform 110 (e.g., one or more servers) which hosts and/or executes one or more of the various functions, processes, methods, and/or software modules described herein. Platform 110 may comprise or be communicatively connected to a server application 114 and/or one or more databases 116. Platform 110 may comprise dedicated servers, or, alternatively, cloud instances which utilize shared resources of one or more servers. Platform 110 may comprise collocated and/or distributed servers or cloud instances. While only one server application 114 and one set of database(s) 116 are illustrated, it should be understood that the infrastructure may comprise any number of server applications and databases. Platform 110 may be communicatively connected to one or more mobile devices 130 via one or more networks 120.

Network(s) 120 may comprise the Internet, wireless communication networks, local home networks, any other network, and/or any combination of networks. As illustrated, network(s) 120 comprise or are communicatively connected to a primary network 122A and an alternative network 122B. In an embodiment, each of primary network 122A and alternative network 122B comprises a wireless communication network which communicates with a radio of mobile device(s) 130 via a wireless communication protocol. For example, primary network 122A may comprise a cellular network which utilizes 2G (e.g., GSM, GPRS, EDGE, iDEN, TDMA, Code-Division Multiple Access (CDMA)), 3G (e.g., CDMA2000, 1×-EVDO, WCDMA, UMTS, HSPA), 4G (e.g., Long-Term Evolution (LTE), LTE-A), 5G, etc., whereas alternative network 122B may comprise a Wi-Fi™ network (e.g., one or more of the family of 802.11 standards from The Institute of Electrical and Electronic Engineers (IEEE)).

Mobile device(s) 130 may comprise any type or types of computing devices capable of wireless communication, including without limitation, desktop computers, laptop computers, tablet computers, smart phones or other mobile phones, servers, game consoles, televisions, set-top boxes, electronic kiosks, point-of-sale terminals, Automated Teller Machines, and the like. In an embodiment, each mobile device 130 comprises a first radio system 132A, a second radio system 132B, a client application 134, and a local database 136. Mobile device 130 may be configured to turn on or off one or both of the first and second radio systems 132A and 132B independently of each other. The first radio system 132A uses a first wireless communication protocol (e.g., a protocol used for a cellular network) to wirelessly connect to an access point 124A (e.g., a cellular base station serving a sector of a cellular network), which provides access to primary network 122A. The second radio system 132B uses a second wireless communication protocol (e.g., Wi-Fi™) to wirelessly connect to an access point 124B (e.g., a Wi-Fi™ access point), which provides access to alternative network 122B. It should be understood that the first wireless communication protocol may be different from the second wireless communication protocol.

As used herein, the term “application” may refer to any executable software module or library of software modules that exists on platform 110 (e.g., as server application 114), mobile device 130 (e.g., as client application 134), or both platform 110 and mobile device 130 (e.g., with some functions executed, as modules of server application 114, on platform 110, and some functions executed, as modules of client application 134, on mobile device 130).

Any of the software modules or other components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application or operating system. It may also be available as a client-server software application, as a web-enabled software application, and/or as a mobile application.

1.2. Example Processing Device

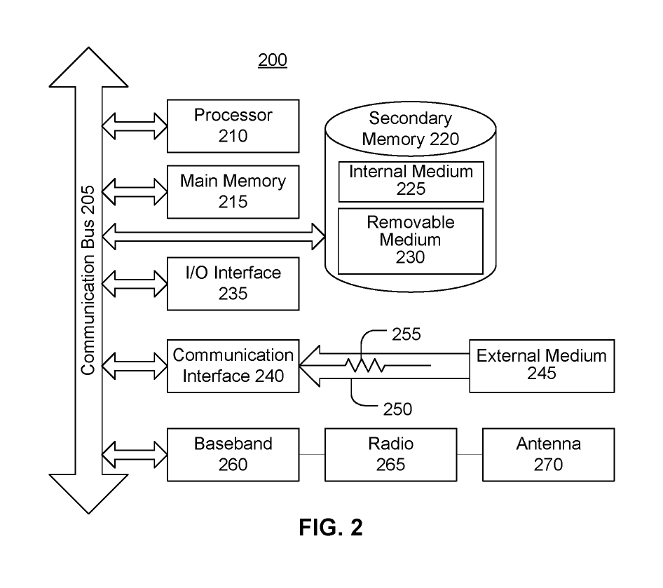

FIG. 2 is a block diagram illustrating an example wired or wireless system 200 that may be used in connection with various embodiments described herein. For example system 200 may be used as or in conjunction with one or more of the mechanisms, processes, methods, or functions (e.g., to store and/or execute the application or one or more software modules of the application) described herein, and may represent components of platform 110, mobile device(s) 130, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors, such as processor 210. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 210. Examples of processors which may be used with system 200 include, without limitation, the Pentium® processor, Core i7® processor, and Xeon® processor, all of which are available from Intel Corporation of Santa Clara, Calif.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPM), IEEE 696/S-100, and the like.

System 200 preferably includes a main memory 215 and may also include a secondary memory 220. Main memory 215 provides storage of instructions and data for programs executing on processor 210, such as one or more of the functions and/or modules discussed above. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 may optionally include an internal memory 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, etc.

Removable storage medium 230 is a non-transitory computer-readable medium having stored thereon computer-executable code (e.g., disclosed software modules) and/or data. The computer software or data stored on removable storage medium 230 is read into system 200 for execution by processor 210.

In alternative embodiments, secondary memory 220 may include other similar means for allowing computer programs or other data or instructions to be loaded into system 200. Such means may include, for example, an external storage medium 245 and a communication interface 240, which allows software and data to be transferred from external storage medium 245 to system 200. Examples of external storage medium 245 may include an external hard disk drive, an external optical drive, an external magneto-optical drive, etc. Other examples of secondary memory 220 may include semiconductor-based memory such as programmable read-only memory (PROM), erasable programmable read-only memory (EPROM), electrically erasable read-only memory (EEPROM), or flash memory (block-oriented memory similar to EEPROM).

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 200 with a network or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network, or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (i.e., computer programs, such as the disclosed application, or software modules) is stored in main memory 215 and/or the secondary memory 220. Computer programs can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code (e.g., software and computer programs) to system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable mediums are means for providing executable code, programming instructions, and software to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform the features and functions described elsewhere herein.

In an embodiment, I/O interface 235 provides an interface between one or more components of system 200 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and the like.

System 200 may also include optional wireless communication components that facilitate wireless communication over a voice network and/or a data network. The wireless communication components comprise an antenna system 270, a radio system 265, and a baseband system 260. In system 200, radio frequency (RF) signals are transmitted and received over the air by antenna system 270 under the management of radio system 265.

In one embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also codes the digital signals for transmission and generates a baseband transmit audio signal that is routed to the modulator portion of radio system 265. The modulator mixes the baseband transmit audio signal with an RF carrier signal generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor 210, which may be a central processing unit (CPU). Processor 210 has access to data storage areas 215 and 220. Processor 210 is preferably configured to execute instructions (i.e., computer programs, such as the disclosed application, or software modules) that can be stored in main memory 215 or secondary memory 220. Computer programs can also be received from baseband processor 260 and stored in main memory 210 or in secondary memory 220, or executed upon receipt. Such computer programs, when executed, enable system 200 to perform the various functions of the disclosed embodiments. For example, data storage areas 215 or 220 may include various software modules.

2. Process Overview

Embodiments of processes for radio management will now be described in detail. It should be understood that the described processes may be embodied in one or more software modules that are executed by one or more hardware processors, e.g., as the application discussed above (e.g., server application 112, client application 134, and/or a distributed application comprising both server application 112 and client application 134), which may be executed wholly by processor(s) of platform 110, wholly by processor(s) of mobile device(s) 130, or may be distributed across platform 110 and mobile device(s) 130 such that some portions or modules of the application are executed by platform 110 and other portions or modules of the application are executed by mobile device(s) 130. The described process may be implemented as instructions represented in source code, object code, and/or machine code. These instructions may be executed directly by the hardware processor(s), or alternatively, may be executed by a virtual machine operating between the object code and the hardware processors. In addition, the disclosed application may be built upon or interfaced with one or more existing systems.

In an embodiment, any set of one or more of the processes described herein may be implemented as a pluggable library that any host application can “plug in” to gain the benefits of those processes. Preferably, the effort required to “plug in” the library is minimal, such as, for example, a few lines of code in the host application to initialize the library and turn it on to begin managing the second radio system 132B (e.g., Wi-Fi™ radio system). In addition, the library may be provided with an application programming interface (API) that comprises a number of methods for the host application to use to gain greater control over the functions of the library. For example, the API may provide a method that allows the host application to extract a list of hotspot locations, so that the host application can display a map of the available hotspot locations.

As an alternative, various embodiments of the disclosed processes may be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

In other words, those of skill in the art will appreciate that the various illustrative logical blocks, modules, circuits, and method steps described herein, and the embodiments disclosed herein can be implemented as electronic hardware, computer software, or combinations of both. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit, or step is for ease of description. Specific functions or steps can be moved from one module, block, or circuit to another without departing from the invention.

In many mobile devices, it is customary to have the cellular radio system (e.g., first radio system 132A) on all the time. The cellular radio system handles communications with the mobile service provider, including voice calls and/or text messages. If there are no connections available via other radio connections, the cellular radio system may also handle any data communication that the mobile device may require. However, in many mobile devices, the data communication is automatically switched over to the Wi-Fi™ radio system (e.g., second radio system 132B) when a connection to the Internet or other backend system or network is available through the Wi-Fi™ radio system. This is because, in most cases, it is less costly and uses less battery power to send data communications over the Wi-Fi™ radio system. Some mobile devices may be equipped with a Wi-Fi™ radio system that is able to communicate with two or more access points (e.g., using different Wi-Fi™ protocols).

The mobile device (e.g., via application 134) may turn on the Wi-Fi™ radio system only in certain circumstances, for example, when a Wi-Fi™ access point is likely to be available. When the Wi-Fi™ radio system is turned on, it will scan the environment to see what, if any, Wi-Fi™ access points are reachable within the environment, and whether or not those Wi-Fi™ access points require a password or other credentials to establish a connection. If there is an access point available to the mobile device, the mobile device will connect to it, for example, to offload at least some wireless services (e.g., data communications, Short Message Service (SMS) communications, and/or voice communications) from the cellular network (e.g., primary network 122A) to the Wi-Fi™ network (e.g., alternative network 122B).

Examples of such radio management may be found, for example, in U.S. Patent Pub. Nos. 2013/0322329, 2013/0322400, 2013/0322401, 2014/0293829, 2015/0189569, 2015/0189580, 2015/0189098, 2015/0282240, 2016/0192289, and 2016/0262201, which are all hereby incorporated herein by reference as if set forth in full.

2.1. Activity Detection

In an embodiment, in order to more expediently identify the availability of alternative network 122B, the application is more aggressive with waking up second radio system 132B to scan the environment, under circumstances in which a change in the user's activity indicates a higher likelihood that an access point 124B to alternative network 122B is available. By way of illustration, a change in a user's activity may include the user entering or exiting a vehicle (e.g., automobile, bicycle, etc.), changing from stationary to moving or moving to stationary, and the like. When the change in the user's activity is likely to increase the availability of a connection to an access point 124B, the application may wake up second radio system 132B to immediately perform a scan of the environment and/or reduce the wake-up interval for second radio system 132B relative to its value before the change in activity was detected. Conversely, when a change in the user's activity is likely to decrease the availability of a connection to an access point 124B, the application may turn off second radio system 132B and/or increase the wake-up interval for second radio system 132B relative to its value before the change in activity was detected.

For example, the application may wake up second radio system 132B and immediately scan the environment, when it detects that the user has been in a vehicle for a certain amount of time and then exited the vehicle. Another example which generally indicates an increased likelihood of an available connection to an access point 124B, is when the user has been moving (e.g., walking, running, biking) for a certain amount of time and then come to a stop. More specific examples of circumstances under which second radio system 132B should scan more aggressively include, without limitation: the application detects that the user has been in a vehicle for five minutes or longer and then exits the vehicle; the application detects that the user has been on a bicycle for five minutes or longer and then gets off the bicycle; and the application detects that the user has been in motion (e.g., indicative of walking, running, biking, driving, or riding in a vehicle) for five minutes or longer and then comes to a complete stop. The complete stop may comprise being substantially stationary (e.g., a moving speed under a threshold indicative of walking for at least a certain period of time, such as five minutes). Under these circumstances, it is likely that the user has reached his or her destination, which makes it more probable that the mobile device may encounter an access point 124B (e.g., a hotspot) to which second radio system 132B can connect.

As a more detailed example, in an embodiment, when the application detects that mobile device 130 has been in a vehicle or on foot for a certain amount of time (e.g., five minutes or longer) and then detects that mobile device 130 is outside the vehicle or has come to a stop, the application reduces the wake-up or scan interval of second radio system 132B to a reduced interval (e.g., two minutes), such that second radio system 132B scans the environment every reduced interval (e.g., two minutes) for the next ten minutes. This gives second radio system 132B a good chance of connecting to an access point 124B (e.g., hotspot) soon after mobile device 130 has left the vehicle or come to a stop, i.e., indicating that the user has reached his or her destination.

In an embodiment, the application comprises one or more isActivity( ) methods for determining in which activity or activities a mobile device 130 is currently or not currently engaged. For example, an isInVehicle( ) method may report whether or not mobile device 130 is currently in a vehicle (e.g., by returning a Boolean of “true” if mobile device 130 is in a vehicle and “false” if mobile device 130 is not in a vehicle). An isStill( ) method may similarly report whether or not mobile device 130 is currently stationary. An isMoving( ) method may similarly report whether or not mobile device 130 is currently moving. An isWalking( ) method may similarly report whether or not mobile device is currently moving at a rate that would indicate that the user is walking. It should be understood that the application may comprise similar methods for other types of activities.

The application may determine whether the mobile device 130 is stationary or moving based on a moving speed of the mobile device 130. The moving speed of the mobile device 130 may be determined by calculating a distance traveled (e.g., based on changes in Global Positioning System (GPS) coordinates, determined by a GPS sensor in mobile device 130) over time. The moving speed may be calculated as an average speed over a past time window.

In addition, the application may distinguish whether the mobile device 130 is with a user who is walking or in a vehicle based on a value of the calculated moving speed of the mobile device 130. For example, if the moving speed is below 1 mile per hour (mph), the application may determine that the user is substantially stationary, if the moving speed is below 5 mph, the application may determine that the user is walking, and, if the moving speed is over 25 mph (e.g., 25-100 mph), the application may determine that the user is in a vehicle. Other activities can be distinguished from each other, using the moving speed, in a similar manner. For example, the application may determine that a user is jogging if the moving speed is 5-10 mph, determine that a user is riding a bicycle if the moving speed is 10-25 mph, determine that a user is in a train if the moving speed is 100-200 mph, and/or determine that a user is in an airplane if the moving speed is over 500 mph.

In an embodiment, the application comprises one or more getDuration( ) methods, which report how long a mobile device 130 has been continuously engaged in a particular activity. For example, a getInVehicleDuration( ) method may report how long mobile device 130 has been continuously in a vehicle and/or was continuously in a vehicle the last time it was in a vehicle. A getOutofVehicleDuration( ) method may similarly report how long mobile device 130 has been continuously outside a vehicle and/or was continuously outside a vehicle the last time it was outside a vehicle. A getMovingDuration( ) method may similarly report how long mobile device 130 has been continuously moving and/or was continuously moving the last time it was moving. A getStillDuration( ) method may similarly report how long mobile device 130 has been continuously stationary or substantially stationary and/or was continuously stationary or substantially stationary the last time it was stationary or substantially stationary. It should be understood that the application may comprise similar methods to determine the duration of any other type of activity. Notably, these getDuration( ) methods have a dampening effect on extraneous false positives, thereby reducing false triggers. False triggers waste resources (e.g., battery power) by, for example, scanning the environment at times during which no connection opportunity is likely available. For example, when mobile device 130 is in a vehicle, the application should ignore momentary stops at a stop light, since mobile device 130 is still in the vehicle and the vehicle will begin to move again shortly. Accordingly, the getInVehicleDuration( ) threshold for triggering more aggressive scanning should be set higher than the length of a typical traffic-light stop (e.g., more than five or ten minutes).

These methods for determining the current activity (or lack thereof) and the duration of an activity may be used in combination to determine whether or not the aggressiveness of scanning should be increased (e.g., in the form of an immediate scan of the environment and/or a decrease in a wake-up or scan interval). For example, if !isInVehicle( ) and getInVehicleDuration( )>x, where x represents a time value (e.g., 5 minutes), this indicates that the user was previously in a vehicle for x amount of time, but is no longer in the vehicle. As another example, if isWalking( ) or isStationary( ) and getInVehicleDuration( )>x, this indicates that the user was previously in a vehicle for x amount of time, but is now walking or stationary. If isStationary( ) and getMovingDuration( )>x, this indicates that the user was previously moving, but is now stationary.

In each of these examples, the application may cause second radio system 132B to perform an immediate scan and/or reduce a wake-up or scan interval of second radio system 132B (e.g., to two minutes), such that second radio system 132B scans more frequently in order to more aggressively scan the environment. In an embodiment, the scan interval may be reduced for a predefined period of time (e.g., ten minutes), after which time, the scan interval may be increased to its original amount of time if no available access point 124B is identified. For example, the scan interval may be reduced from fifteen minutes to two minutes for a ten minute period, and after the ten minute period expires without a connection, increased back to fifteen minutes. In other words, the scan interval is set to two minutes if getInVehicleDuration( ) is greater than five minutes and getOutOfVehicleDuration( ) is less than or equal to ten minutes.

In an embodiment, the value, to which the wake-up or scan interval is set (e.g., two minutes in the examples above) upon the detection of a change in activity, may be configurable. In addition, the time period, for which the wake-up or scan interval is reduced (e.g., ten minutes in the examples above), can be a configurable setting. Furthermore, the conditions under which an activity is determined to have changed (e.g., the threshold for the value returned by a getDuration( ) method, the activity determined from an isActivity( ) method, etc.) may also be a configurable setting. Each configurable setting may be set by a user via a user interface that is provided by the application or other software on mobile device 130 and/or platform 110.

In an embodiment, the application, when executed, comprises a work thread that represents the “heartbeat” of the application. While the application is also event driven (e.g., reacting to the completion of a scan by second radio system 132B, a connection to a new hotspot, etc.), the work thread maintains a “heartbeat” to perform occasional maintenance tasks. At each heartbeat, the work thread checks whether there is anything to do, such as perform a scan, update a current transaction, request data updates (e.g., new setting, new hotspot locations, etc.) from platform 110, post data (e.g., scan reports, data usage, etc.) to platform 110, and/or the like. Since each “heartbeat” consumes battery power and may utilize data communications, the “heartbeat” may be throttled by varying the interval between “heartbeats.” For example, when the user of mobile device 130 is present (e.g., when the display is on or active), the “heartbeat” may be faster (i.e., shorter intervals between “heartbeats”) to make the application more responsive (e.g., connect to an access point 124B faster). On the other hand, when the user is not present (e.g., when the display is off or inactive) and there are no vital activities occurring (e.g., no need to track data usage over a Wi-Fi connection), the “heartbeat” may be slower (i.e., longer intervals between “heartbeats”).

In an embodiment, the scan interval may be limited by the interval of the work thread (or sleep thread), which can be minutes (e.g., a default of five minutes if mobile device 130 is sleeping and not associated with an access point 124B). In this case, the sleep thread should check whether the user's activity has changed, and, if so, adjust its interval to match the adjusted scan interval.

In an embodiment, the work thread may check whether there has been a change in the user's activity at an activity interval (e.g., each “heartbeat,” a certain number of “heartbeats,” or at the first heartbeat following a predefined time interval). For example, to determine whether or not the user has entered or exited a vehicle, the work thread may check the getInVehicleDuration( ) method, the getOutOfVehicleDuration( ) method, and/or the isInVehicle( ) method after each activity interval, to determine whether or not the application needs to perform more aggressive scanning (i.e., immediate scan and/or shorter scan intervals) or less aggressive scanning (e.g., longer scan intervals).

In an embodiment, activity detection is not event driven. Generally, if an application wants to detect whether mobile device 130 is in a vehicle or a user is walking, or otherwise moving, or stationary, the application must poll one or more motion sensors. In other words, the motion sensors do not typically push an event to the application, when motion characteristics change. Thus, in an embodiment, the application executes a loop that polls the motion sensors according to the activity interval and identifies the current activity of mobile device 130. The loop may be endless or, to conserve battery, may be stopped (e.g., when Wi-Fi is connected, since activity detection is no longer needed for triggering new scans) and started (e.g., when Wi-Fi is not connected, so that new scans can be triggered) at various times. A shorter activity interval provides faster detection of an activity change (e.g., instantaneous), but consumes more battery power. A longer activity interval provides slower detection of an activity change, but consumes less battery power. However, if the activity interval is too long, the application may miss changes in motion characteristics that would indicate a change in activity, and thereby fail to properly detect a change in activity (e.g., not detect that a user has exited a vehicle). Empirically, an activity interval of two minutes appropriately balances this tradeoff between detection speed and battery consumption. Notably, a two-minute activity interval is somewhat less than the durations (e.g., five minutes) used, in the examples above, to trigger more aggressive scanning. In such an embodiment, with a two-minute activity interval and a five-minute activity duration condition, the application will “see” mobile device 130 involved in an activity (e.g., in a vehicle) for at least two, possibly three, consecutive measurements. This generally provides sufficient resolution to have confidence that mobile device 130 has not been successively performing and stopping an activity (e.g., entering and exiting a vehicle), so as to prevent the more aggressive scanning from being inappropriately triggered.

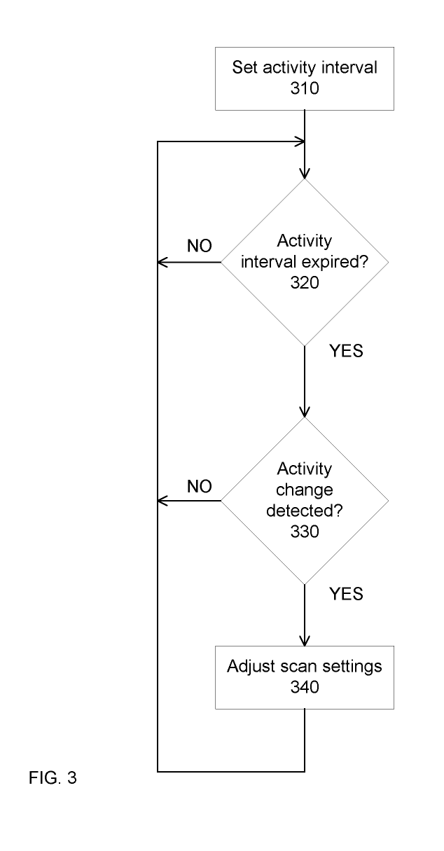

FIG. 3 illustrates a process for activity-based adjustment of the aggressiveness of scanning using second radio system 132B (e.g., a Wi-Fi radio system), according to an embodiment. In step 310, an activity interval is set. The activity interval may be a system setting. Alternatively, the activity interval may be a user setting, which can be configured via a user interface provided by the application or other software. In this case, the activity interval may have a default value (e.g., two minutes).

In step 320, the application determines whether or not the activity interval has expired. As discussed above, this determination may be performed by the work thread. Additionally or alternatively, the determination may be performed using a timer that expires at the end of each activity interval. If the activity interval has not expired (i.e., “NO” in step 320), the application waits until the activity interval expires. On the other hand, if the activity interval has expired (i.e., “YES” in step 320), the application proceeds to step 330.

In step 330, the application determines whether a change in activity has occurred. As discussed above, this determination may comprise determining the current activity (or lack of activity) of mobile device 130 and/or the duration of a preceding activity. For example, if isInVehicle( ) returns “false” and getInVehicleDuration( ) is greater than a predetermined threshold (e.g., five minutes), this indicates that a user has recently driven to his or her desired destination and exited the vehicle. If no activity, to be detected, has changed (i.e., “NO” in step 330), the application waits until expiration of the next activity interval before checking again. Otherwise, if an activity, to be detected, has changed (i.e., “YES” in step 330), the application proceeds to step 340.

In step 340, the scan settings for second radio system 132B are adjusted. As discussed above, if the detected change in activity indicates a higher likelihood that an access point 124B to alternative network 122B is available for connection via second radio system 132B (e.g., the user exiting a vehicle or becoming substantially stationary), step 340 may involve adjusting the scan settings to be more aggressive, for example, by triggering an immediate scan of the environment by second radio system 132B and/or by decreasing the wake-up interval or scan interval between scans of the environment by second radio system 132B. Conversely, if the detected change in activity indicates a lower likelihood that an access point 124B to alternative network 122B is available for connection via second radio system 132B (e.g., the user entering a vehicle or moving at a brisk pace), step 340 may involve adjusting the scan settings to be less aggressive, for example, by turning off second radio system 132B and/or increasing the wake-up interval or scan interval between scans of the environment by second radio system 132B. By adjusting the aggressiveness of the scanning, performed by second radio system 132B, an appropriate trade-off between responsiveness and battery consumption may be achieved.

2.2. Location Proximity

Alternatively or in addition to the activity-based adjustment discussed above, the application may also utilize location-based scanning, performed by second radio system 132B. Specifically, the application may monitor the current location of mobile device 130 as mobile device 130 moves around. In an embodiment, the application uses this location tracking to initiate scans in areas in which mobile device 130 has previously been. This can improve the likelihood that an available access point 124B will be found and provide the user with a better Wi-Fi experience.

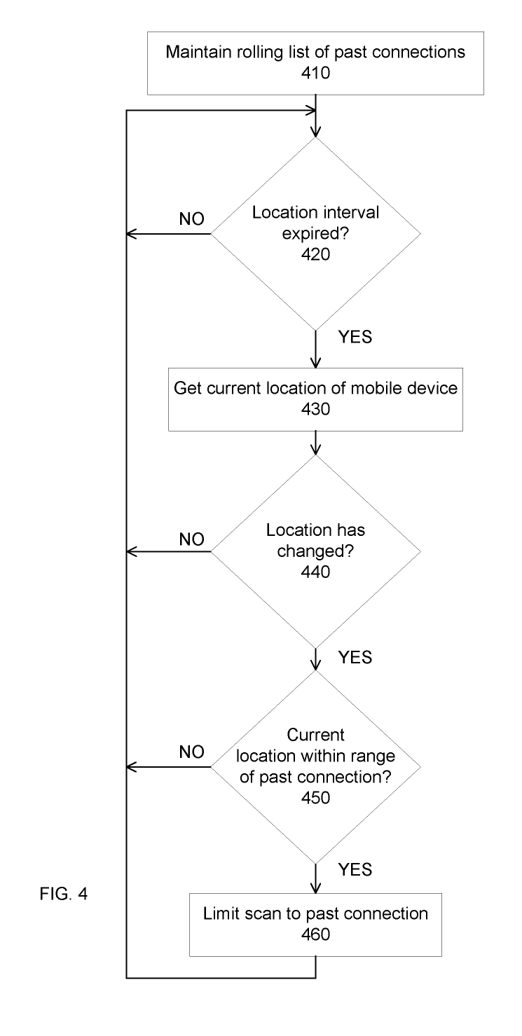

FIG. 4 illustrates a process for location-based adjustment of the aggressiveness of scanning using second radio system 132B (e.g., a Wi-Fi radio system), according to an embodiment. In step 410, the application maintains a rolling list of past connections, in which the second radio system 132B successfully established a connection with an access point 124B to alternative network 122B. For example, the rolling list of past connections may be stored in local database 136 and may comprise a list of past connections for a predetermined past period of time (e.g., the last ninety days). For each past connection, the list may comprise an identifier of the access point 124B to which second radio system 132B connected and a location (e.g., GPS coordinates, street address, etc.) at which the connection occurred.

In step 420, the application determines whether or not a location interval (e.g., two minutes) has expired. Similarly to the activity interval, this determination may be performed by the work thread, and the location interval may be configurable by a user or a system (e.g., client application 134, server application 114, or another application or platform). Additionally or alternatively, the determination may be performed using a timer that expires at the end of each location interval. If the location interval has not expired (i.e., “NO” in step 420), the application waits until the location interval expires. On the other hand, if the location interval has expired (i.e., “YES” in step 420), the application proceeds to step 430.

In step 430, the application acquires the current location of mobile device 130 (e.g., from a GPS receiver installed in mobile device 130).

In step 440, the application determines whether or not the current location of mobile device 130, acquired in step 430, has changed (e.g., since the location acquired at the immediately preceding location interval). If the location has not changed (i.e., “NO” in step 440), the application waits until the next location interval has expired. On the other hand, if the location has changed (i.e., “YES” in step 440), the application proceeds to step 450.

In step 450, the application compares the current location of mobile device 130, acquired in step 430, to the locations of the past connections maintained in the rolling list of past connections (e.g., stored in local database 136). If the current location of mobile device 130 is not within a predetermined range or radius (e.g., one-hundred meters) of any of the locations of the stored past connections (i.e., “NO” in step 450), the application waits until the next location interval expires. If the current location of mobile device 130 is within a predetermined range or radius (e.g., one-hundred meters) of the location of one or more past connections (i.e., “YES” in step 450), the application proceeds to step 460.

In an embodiment, the determination in step 450 may also be made with respect to a blacklist of access points (e.g., stored in local database 136). Specifically, if a location of a past connection is within the predetermined range of the current location of mobile device 130, but the past connection was to an access point 124B identified in the blacklist, the determination in step 450 is “NO” with respect to that past connection. This prevents second radio system 132B from attempting to connect to an access point that has been previously blacklisted (e.g., by the user manually disconnecting or forgetting the access point), thereby improving the user's experience.

In step 460, the application may limit scanning by second radio system 132B to the one or more past connections identified in step 450. For example, if mobile device 130 enters within the predetermined range (e.g., one-hundred meters) of a location at which mobile device 130 previously connected to a particular hotspot, the application may wake second radio system 132B to perform an immediate scan for that particular hotspot. The application may continue to limit scanning to the past connections identified in step 450 for as long as mobile device 130 remains within the predetermined range from access points 124B associated with those past connections. In addition, the application may perform more aggressive scanning for those access points 124B associated with those past connections, for as long as mobile device 130 is within the predetermined range from the past connections, for example, by shortening the wake-up or scan interval for second radio system 132B.

In an embodiment, once mobile device 130 enters within the predetermined range from a past connection, in step 450, the application only compares the current location of mobile device 130 to the locations of that past connection until mobile device 130 is outside the predetermined range from that past connection. Subsequently, each time mobile device 130 moves closer to that same past connection (e.g., as determined in steps 440 and 450), the application causes second radio system 132B to run a single scan for the access point associated with the past connection. Eventually, second radio system 132B will either connect to the access point associated with the particular past connection, get so close to the access point that no additional scans will be performed, or move out of the predetermined range from the access point, in which case second radio system 132B will once again scan for all available or past connections instead of limiting the scans to that particular past connection.

2.3. Policy Management

Alternatively or in addition to the activity-based adjustment and location-based scanning discussed above, the application may activate or deactivate automated radio management of second radio system 132B based on one or more conditions affecting mobile device 130. It should be understood that, when the automated radio management of second radio system 132B is turned off or deactivated, a user may still be able to perform manual radio management (e.g., turning on Wi-Fi™, selection of an access point 124B, etc.).

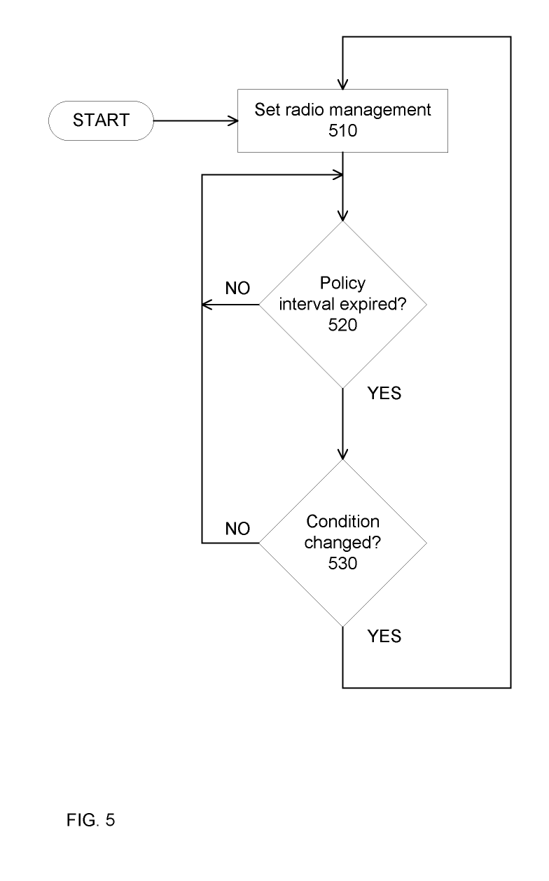

FIG. 5 illustrates a process for activating or deactivating radio management of second radio system 132B (e.g., a Wi-Fi™ radio system), according to an embodiment. The process may begin in step 510 with the system or a user setting the radio management of second radio system 132B to on or off. By default, radio management may be set to on or active. When the radio management is in the on or active state, the application may turn second radio system 124B on, automatically scan for access points 124B to alternative network 122B, and/or automatically connect to available access points 124B to alternative network 122B. Conversely, when the radio management is in the off or inactive state, the application may not turn the second radio system 124B on or off, not automatically scan for access points 124B, and/or not automatically connect to available access points 124B.

In step 520, the application determines whether or not a policy interval (e.g., two minutes) has expired. Similarly to the activity and location interval, this determination may be performed by the work thread, and the policy interval may be configurable by a user. Additionally or alternatively, the determination may be performed using a timer that expires at the end of each policy interval. If the policy interval has not expired (i.e., “NO” in step 520), the application waits until the policy interval expires. On the other hand, if the policy interval has expired (i.e., “YES” in step 520), the application proceeds to step 530.

In step 530, the application determines whether a condition (which may include a set of one or more criteria) has changed. If the condition has not changed (i.e., “NO” in step 530), the application waits until the policy interval expires again. On the other hand, if the condition has changed (i.e., “YES” in step 530), the application sets the radio management to on or off based on the changed condition.

For example, the condition may be whether or not mobile device 130 is in-network (e.g., within the cellular network of the mobile network operator (MNO) to which the user is subscribed) or roaming (e.g., within a cellular network not operated by the MNO to which the user is subscribed). When mobile device 130 is in-network, the user may not wish to utilize automatic radio management for alternative network 122B. Thus, in an embodiment, if the application determines, in step 530, that mobile device 130 is in-network, the application may turn off the radio management of second radio system 132B in step 510. Conversely, if the application determines, in step 530, that mobile device 130 is roaming, the application may turn on the radio management of second radio system 132B in step 510. The idea is to not automatically manage second radio system 132B (e.g., including automatic connections) while mobile device 130 is in-network, for example, to prevent Wi-Fi™ connections beyond those Wi-Fi™ connections that the user manually establishes.

In an embodiment, the process, illustrated in FIG. 5, of automatically activating or deactivating the radio management of second radio system 132B may itself be turned on or off by a user. For example, the user may view whether or not this process is activated or deactivated and/or activate or deactivate this process via a user interface provided by the application or other software. In addition, a user interface of the application, operating system, or other software should indicate to the user (e.g., in a notification area) whether the radio management of second radio system 132B is currently on or off, since, when the radio management is off, it represents a suspension of services.

Without limitation, the condition(s) checked in step 530 may comprise one or more of the following:
Whether mobile device 130 is in-network or roaming. As discussed above, radio management of second radio system 132B may be turned off when mobile device 130 is in-network, and turned on when mobile device 130 is roaming.
Strength of a cellular signal being received by first radio system 132A. For example, radio management of second radio system 132B may be turned off when first radio system 132A is receiving a strong (e.g., above a threshold) cellular signal (e.g., from access point 124A, which may be a cellular base station), and turned on when first radio system 132A is receiving a weak (e.g., below a threshold) cellular signal.
Cellular encoding or network type being used by first radio system 132A. For example, radio management of second radio system 132B may be turned off when the cellular encoding used in communications between first radio system 132A and access point 124A is high (e.g., 4G/LTE or above a threshold), and turned on when the cellular encoding is low (e.g., not 4G/LTE or below a threshold).
Cellular sector in which mobile device 130 is located and/or time frame. For example, radio management of second radio system 132B may be turned off when mobile device 130 is not located in a particular cellular sector of primary network 122A (e.g., a cellular network) and/or outside of a particular time period, and turned on when mobile device 130 is located within the particular cellular sector of primary network 122A and/or during the particular time period. For example, the radio management may be turned on if mobile device 130 is in a cellular sector of primary network 122A during a time period in which that cellular sector is experiencing or is predicted to experience a high traffic load. Turning on the radio management of second radio system 132B under such circumstances enables offloading of mobile device 130 from primary network 122A to alternative network 122B. The cellular sectors and/or time periods that trigger such offloading may be defined by the MNO of primary network 122A, and may be based on historical traffic patterns for cellular sectors and time periods.
Geofence in which mobile device 130 is located and/or time frame. For example, radio management of second radio system 132B may be turned off when mobile device 130 is located or not located in a particular geofence and/or during a particular time period, and turned on when mobile device 130 is not located or located in the particular geofence and/or outside the particular time period. Again, such radio management enables offloading of mobile device 130 from primary network 122A to alternative network 122B, for example, during time periods in which the geofence is experiencing high traffic load. The geofences, which may be defined by a set of GPS coordinates (e.g., latitude and longitude pairs) that represent the boundaries of a polygon and/or a GPS coordinate in conjunction with a radius that together represent a circle, and/or time periods that trigger such offloading may be defined by the MNO of primary network 122A, and may be based on historical traffic patterns for the geofences and time periods.

Generally, first radio system 124A provides a method for determining whether mobile device 130 is in-network or roaming, cellular signal strength, etc. For example, the API for the Android™ operating system provides a method that reports whether or not a mobile device is considered to be in-network or roaming. Accordingly, the application may use this method to determine whether or not mobile device 130 is in-network or roaming. The Android™ API also provides the current cellular signal strength of first radio system 132A, the encoding type used for communication by first radio system 132A, and the sector identifier (cell identification and operator identification) for the sector of the cellular network in which mobile device 130 is located. Accordingly, for the Android operating system, the application can utilize these methods of the Android™ API to determine the various conditions considered in step 530. Other operating systems provide similar methods and APIs for determining these conditions in step 530.

In an embodiment, the states (e.g., parameter values) for determining whether or not a condition is satisfied (e.g., in-network, roaming, signal quality, encoding, sector identifier, location, etc.) may be transmitted by client application 134 on mobile device 130 to server application 114 on platform 110 (e.g., via either first radio system 132A, access point 124A, and primary network 122A, or via second radio system 132B, access point 124B, and primary network 122B). In this case, the determination in step 530 may be performed by server application 114 on platform 110, and server application 114 may transmit an instruction, based on the result of the determination in step 530, to client application 134 on mobile device 130 to turn the radio management of second radio system 132B on or off.

In an embodiment in which client application 134 on mobile device 130 takes instruction from server application 114 on platform 110, server application 114 can control whether or not radio management is performed on mobile device 130. This enables the operator of platform 110 to turn radio management features on or off, depending on whether or not the user of mobile device 130 is current on payments to the operator.

In an embodiment, server application 114 on platform 110 can determine whether or not a premium connection between second radio system 132B and an access point 124B should be made based on states transmitted from client application 134 to server application 114. A premium connection may comprise features that are not otherwise available. In such an embodiment, step 530 may be performed by server application 114, client application 134, or both. For example, client application 134 may perform the determination in step 530 of whether or not to perform radio management (e.g., for amenity hotspots or Android-configured hotspots, such as those at the user's home or work) locally on mobile device 130, while server application 114 may determine whether or not a premium connection should be established and transmit the determination to client application 134.

In an embodiment, when a mobile device 130 transitions between a condition in which the radio management of second radio system 132B is active to a condition in which the radio management is passive (e.g., mobile device transitions from roaming to in-network), second radio system 132B may simply be turned off. Alternatively, second radio system 132B may remain active in certain circumstances, since always turning second radio system 132B off or always keeping the second radio system 132B on, every time such a transition occurs, may annoy the user. Thus, in an embodiment, the application can “follow” the user's prior choice by remembering what the user did after a prior transition and/or based on other various decision factors. For example, if the application had turned off the radio management and second radio system 132B following a similar past transition and the user manually turned second radio system 132B back on, the application can keep second radio system 132B active after a subsequent transition. Conversely, if the application had kept the radio management active and second radio system 132B on following a similar past transition and the user manually turned second radio system 132B off, the application can turn off second radio system 132B after a subsequent transition. In either case, if second radio system 132B is performing communication (e.g., Wi-Fi communication) during the transition, the application may keep second radio system 132B on, irrespective of the user's prior choice and/or the default action.

In an embodiment, one or more settings may define how the radio management on a mobile device 130 should behave during or after a voice call. These setting(s) may be set by the system or a user. In embodiments in which server application 114 on platform 110 controls or otherwise manages the radio management of mobile device 130, the setting(s) may be stored on platform 110 (e.g., in database(s) 116), and server application 114 may, via network(s) 120, instruct client application 134 as to how to behave in order to implement the setting(s). The setting(s) may be selected so as to prevent issues that may arise, for example, in the context of Voice-over-LTE (VoLTE), Voice-over-Internet-Protocol (VoIP), and/or Voice-over-Wi-Fi (VoWiFi) calls, as a result of switching between cellular and Wi-Fi™ networks. The setting(s) may include, without limitation, one or more of the following for one or more of the radio systems 132 in each mobile device 130:
Whether or not a particular radio system (e.g., first radio system 132A and/or second radio system 132B, which may be a Wi-Fi™ radio system) can be disabled (e.g., switched from active to inactive or on to off) during a voice call. By default, this setting may be set to true (i.e., the particular radio system can be disabled during a voice call). Notably, when this setting is set to true and the voice call is being carried on the particular radio system (e.g., 132B), if the particular radio system is disabled during the voice call, the voice call may be transferred from the particular radio system to another radio system (e.g., 132A).
Whether or not a particular radio system (e.g., first radio system 132A and/or second radio system 132B, which may be a Wi-Fi™ radio system) can be enabled (e.g., switched from inactive to active or off to on) during a voice call. By default, this setting may be set to false (i.e., the particular radio system cannot be enabled during a voice call). Notably, when this setting is set to true and the voice call is being carried on another radio system (e.g., 132A), if the particular radio system (e.g., 132B) is enabled during the voice call, the voice call may be transferred from the other radio system to the particular radio system (if appropriate in the course of normal radio management).
A delay time period that must elapse, following termination of a voice call, before radio management can resume. By default, the value of this setting may be zero milliseconds, which would allow the radio management to resume immediately upon termination of the voice call. If the value of this setting is a non-zero N seconds (e.g., one hundred milliseconds), then radio management of the particular radio system(s) associated with the setting may not begin until the voice call has been terminated for at least N seconds (i.e., N seconds have elapsed since termination of the voice call). A non-zero value for this setting may aid in the context of emergency voice calls, for example, by preventing an immediate network change, which may adversely affect communications, in the middle of an emergency.
Whether or not automatic connections by a particular radio system are enabled during the voice call. By default, this setting may be set to true, in which case the particular radio system may automatically connect, without user intervention or confirmation, to an access point during the voice call (e.g., where the voice call is being carried on another radio system). Otherwise, if this setting is set to false, the particular radio system may not automatically connect (e.g., may require user confirmation or may not be allowed to connect at all) to an access point during the voice call (e.g., where the voice call is being carried on another radio system).

In an embodiment, the radio management in a mobile device 130 may prevent a radio system 132 from being turned off for a set time period or delay following a lost connection by that radio system 132. For example, mobile device 130 may have a connection with access point 124B via radio system 132B (e.g., a Wi-Fi™ connection). If radio system 132B loses the connection to access point 124B (e.g., because mobile device 130 moves out of range of access point 124B or due to a failure in access point 124B), the radio management may ensure that radio system 132B remains on for at least a set time period before being turned off After the set time period has elapsed, following the loss of the connection, without reestablishment of the connection (e.g., without access point 124B becoming visible again), the radio management may revert to its normal operation, during which radio system 132B may be turned off. The set time period may be a system or user setting (e.g., managed by either or both of server application 114 and client application 134, via one or more user interfaces provided by either application). By default, the set time period may be ten minutes.

The use of the set time period to create a delay, during which the radio management is not permitted to turn off a particular radio system (e.g., radio system 132B, which may be a Wi-Fi™ radio system), may result in maximizing the utilization of user-configured hotspots (e.g., a user's home Wi-Fi™ network) by accommodating temporary disconnections from those hotspots. Specifically, connections to user-configured hotspots may be temporarily lost (e.g., for a few minutes), for example, due to the user carrying his or her mobile device 130 to an outer area of the user's home, out of the range of the user's home access point (e.g., access point 124B). Instead of simply turning off the particular radio system in response to the lost connection, the delay, preceding resumption of the normal radio management, provides a grace period or time window for the particular radio system to reestablish the connection (e.g., as a result of the user carrying his or her mobile device 130 back into range with the user's home access point). Essentially, if a radio system 132 recently lost a connection to an access point (i.e., within the set time period), the radio management prevents the radio system 132 from being turned off until it is clear that the loss of the connection is not temporary, in order to accommodate momentary connection losses (e.g., due to temporary travel outside the range of an access point).

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A method for a mobile device comprising a first radio system and a second radio system and capable of performing radio management of at least the second radio system, the method comprising using at least one hardware processor to perform automated radio management of the second radio system by:
detecting a change from a first activity to a second activity performed by a user of a mobile device, wherein each of the first activity and the second activity indicates a likelihood for use of the second radio system; and,
in response to the detected change from the first activity to the second activity,
when the likelihood indicated by the second activity is higher than the likelihood indicated by the first activity, increasing an aggressiveness with which the second radio system scans an environment of the mobile device for access points, and,
when the likelihood indicated by the second activity is lower than the likelihood indicated by the first activity, decreasing an aggressiveness with which the second radio system scans the environment of the mobile device for access points.

2. The method of claim 1, wherein increasing the aggressiveness with which the second radio system scans the environment comprises shortening a wake-up interval for performing scans by the second radio system, and wherein decreasing the aggressiveness with which the second radio system scans the environment comprises lengthening a wake-up interval for performing scans by the second radio system.

3. The method of claim 2, wherein the automated radio management further comprises, after expiration of each of a plurality of the wake-up intervals:
enabling the second radio system to initiate a scan of the environment by the second radio system;
when one or more available access points are identified, initiating a connection to at least one of the one or more available access points; and,
when no available access points are identified, disabling the second radio system.

4. The method of claim 2, wherein increasing the aggressiveness with which the second radio system scans the environment further comprises performing an immediate scan of the environment.

5. The method of claim 2, wherein the automated radio management further comprises, after a predetermined time period has passed following a shortening of the wake-up interval, resetting the wake-up interval to its duration before the shortening of the wake-up interval.

6. The method of claim 1, wherein one of the first and second activities comprises a substantially stationary activity, and wherein the other one of the first and second activities comprises a moving activity.

7. The method of claim 6, wherein the moving activity comprises being in a moving vehicle.

8. The method of claim 6, wherein the moving activity comprises walking.

9. The method of claim 6, wherein the first activity comprises the moving activity, wherein the second activity comprises the substantially stationary activity, and wherein detecting a change from the first activity to the second activity comprises determining that the moving activity has been continuously performed for at least a first predetermined time period, followed by the substantially stationary activity being continuously performed for at least a second predetermined time period.

10. The method of claim 9, wherein the first predetermined time period is five minutes or more.

11. The method of claim 9, wherein the automated radio management further comprises determining that the moving activity has been performed when an average moving speed of the mobile device over the first predetermined time period is greater than a first threshold, and determining that the substantially stationary activity is being performed when the average moving speed of the mobile device over the second predetermined time period is less than a second threshold.

12. The method of claim 11, wherein the moving activity comprises being in a moving vehicle, and wherein the first threshold is indicative of a speed of the moving vehicle.

13. The method of claim 6, wherein the first activity comprises the substantially stationary activity, wherein the second activity comprises the moving activity, and wherein detecting a change from the first activity to the second activity comprises determining that the substantially stationary activity has been continuously performed for at least a first predetermined time period, followed by the moving activity being continuously performed for at least a second predetermined time period.

14. The method of claim 1, wherein the automated radio management further comprises determining an activity being performed by the user of the mobile device after expiration of each of a plurality of activity intervals.

15. The method of claim 1, further comprising using the at least one hardware processor to automatically turn off the automated radio management of the second radio system in response to at least one condition being satisfied.

16. The method of claim 15, wherein the at least one condition comprises a determination that the mobile device is connected to its primary network via the first radio system.

17. The method of claim 15, wherein the at least one condition comprises one or both of a determination that a strength of a signal received by the first radio system is above a threshold and a determination that a cellular encoding used by the first radio system is above a threshold.

18. The method of claim 15, wherein the at least one condition comprises a determination that the mobile device is located within a particular sector or geofence.

19. A system comprising:
at least one hardware processor; and
one or more software modules configured to, when executed by the at least one hardware processor,
detect a change from a first activity to a second activity performed by a user of a mobile device, wherein each of the first activity and the second activity indicates a likelihood for use of the second radio system, and,
in response to the detected change from the first activity to the second activity,
when the likelihood indicated by the second activity is higher than the likelihood indicated by the first activity, increase an aggressiveness with which the second radio system scans an environment of the mobile device for access points, and,
when the likelihood indicated by the second activity is lower than the likelihood indicated by the first activity, decrease an aggressiveness with which the second radio system scans the environment of the mobile device for access points.

20. A non-transitory computer-readable medium having instructions stored thereon, wherein the instructions, when executed by a processor, cause the processor to:
detect a change from a first activity to a second activity performed by a user of a mobile device, wherein each of the first activity and the second activity indicates a likelihood for use of the second radio system; and,
in response to the detected change from the first activity to the second activity,
when the likelihood indicated by the second activity is higher than the likelihood indicated by the first activity, increase an aggressiveness with which the second radio system scans an environment of the mobile device for access points, and,
when the likelihood indicated by the second activity is lower than the likelihood indicated by the first activity, decrease an aggressiveness with which the second radio system scans the environment of the mobile device for access points.
